(19) United States
(12) Patent Application Publication
(10) Pub. No.: US 2026/0296656 A1
(43) Pub. Date: Oct. 1, 2026

(54) POWER SUPPLY SYSTEM, MOVING OBJECT, CONTROL METHOD, AND STORAGE MEDIUM

(71) Applicant: HONDA MOTOR CO., LTD., Tokyo (JP)

(72) Inventor: Kenji Noguchi, Wako-shi (JP)

(21) Appl. No.: 19/629,187

(22) Filed: Mar. 26, 2026

(30) Foreign Application Priority Data
Mar. 27, 2025 (JP) 2025-054439

(51) Int. Cl. B64D 27/357

(52) U.S. Cl. CPC B64D 27/357; B64D 2221/00

(57) ABSTRACT

An electrical power supply system includes a voltage conversion device capable of converting a DC voltage supplied from a first electrical power supply subsystem and supplying the converted DC voltage to a second electrical power supply subsystem, and capable of converting a DC voltage supplied from the second electrical power supply subsystem and supplying the converted DC voltage to the first electrical power supply subsystem, and a control unit capable of executing power interchange control for transferring electrical power between the first electrical power supply subsystem and the second electrical power supply subsystem via the voltage conversion device.

### CROSS-REFERENCE TO RELATED APPLICATIONS

This application is based upon and claims the benefit of priority from Japanese Patent Application No. 2025-054439 filed on Mar. 27, 2025, the contents of which are incorporated herein by reference.

### BACKGROUND OF THE INVENTION

### Field of the Invention

The present disclosure relates to an electrical power supply system, a moving object, a control method, and a storage medium.

### Description of the Related Art

JP 2022-529997 A discloses an aircraft electrical energy supply network (power supply system).

### SUMMARY OF THE INVENTION

There is a long awaited need for a more satisfactory electrical power supply system and the like.

The present disclosure has the object of solving the aforementioned problem.

A first aspect of the present disclosure is characterized by an electrical power supply system, wherein the electrical power supply system comprises a first electrical power supply subsystem including a first electrical power supply circuit that supplies, to a first load device, a direct current (DC) electrical power that is output from a first electrical power generating device, a first power storage device that is capable of being connected in parallel with the first electrical power generating device to the first electrical power supply circuit, a second electrical power supply subsystem including a second electrical power supply circuit that supplies, to a second load device, a DC electrical power that is output from a second electrical power generating device, a second power storage device that is capable of being connected in parallel with the second electrical power generating device to the second electrical power supply circuit, a voltage conversion device that is capable of converting a DC voltage that is supplied from the first electrical power supply subsystem and supplying the same to the second electrical power supply subsystem, and further capable of converting a DC voltage that is supplied from the second electrical power supply subsystem and supplying the same to the first electrical power supply subsystem, and a control unit that is capable of executing power interchange control for transferring electrical power between the first electrical power supply subsystem and the second electrical power supply subsystem via the voltage conversion device.

Another aspect of the present disclosure is characterized by a moving object comprising the aforementioned electrical power supply system.

Yet another aspect of the present disclosure is characterized by a control method that control an electrical power supply system, wherein the electrical power supply system comprises a first electrical power supply subsystem including a first electrical power supply circuit that supplies, to a first load device, a DC electrical power that is output from a first electrical power generating device, a first power storage device that is capable of being connected in parallel with the first electrical power generating device to the first electrical power supply circuit, a second electrical power supply subsystem including a second electrical power supply circuit that supplies, a second load device, a DC electrical power that is output from a second electrical power generating device to, a second power storage device that is capable of being connected in parallel with the second electrical power generating device to the second electrical power supply circuit, a voltage conversion device that is capable of converting a DC voltage that is supplied from the first electrical power supply subsystem and supplying the same to the second electrical power supply subsystem, and further capable of converting a DC voltage that is supplied from the second electrical power supply subsystem and supplying the same to the first electrical power supply subsystem, the control method comprising: a determination step of determining whether or not a magnitude of a voltage difference between a first voltage supplied from the first electrical power supply subsystem and a second voltage supplied from the second electrical power supply subsystem is equal to or larger than a predetermined first difference threshold; and a power interchange control step of executing power interchange control for transferring electrical power between the first electrical power supply subsystem and the second electrical power supply subsystem via the voltage conversion device in a case where it is determined in the determination step that the voltage difference is equal to or greater than the first difference threshold.

Yet another aspect of the present disclosure is characterized by a program that causes a computer to execute the aforementioned control method.

Yet another aspect of the present disclosure is characterized by a non-transitory storage medium in which the aforementioned program is stored.

According to the present disclosure, it is possible to provide a satisfactory electrical power supply system and the like.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic diagram of a moving object according to one embodiment;

FIG. 2 is a schematic diagram showing a configuration of an electrical power supply system according to the one embodiment;

FIG. 3 is a circuit diagram showing an example of a DC/DC converter;

FIG. 4 is a block diagram showing a configuration of a control device according to the one embodiment;

FIG. 5 is a flowchart showing an example of operations of the electrical power supply system according to the one embodiment; and

FIG. 6 is a schematic diagram showing a configuration of the electrical power supply system according to an exemplary modification.

### DETAILED DESCRIPTION OF THE INVENTION

In the case where electrical power that needs to be supplied from the electrical power generating device to the load device via the electrical power supply circuit is rapidly increased, it is necessary to increase the electrical power generated by the electrical power generating device that supplies power to the load device, but the gas turbine engine or the like provided as a driving source in the electrical power generating device has a relatively low responsiveness. Therefore, the shortage of the electrical power is compensated for by increasing the supply of the electrical power from the power storage device to the electrical power supply circuit. However, since the power storage device has a certain degree of internal resistance, as the current supplied from the power storage device to the electrical power supply circuit increases, the voltage drop in the power storage device increases. As the voltage drop in the power storage device increases, the voltage of the electrical power supply circuit connected to the power storage device decreases. As the voltage of the electrical power supply circuit is extremely decreased, it becomes difficult to increase the power generated by the electrical power generating device. According to the present disclosure described below, since power can be quickly transferred between one electrical power supply system and the other electrical power supply system, the occurrence of the above-mentioned event can be reliably prevented.

### Embodiments

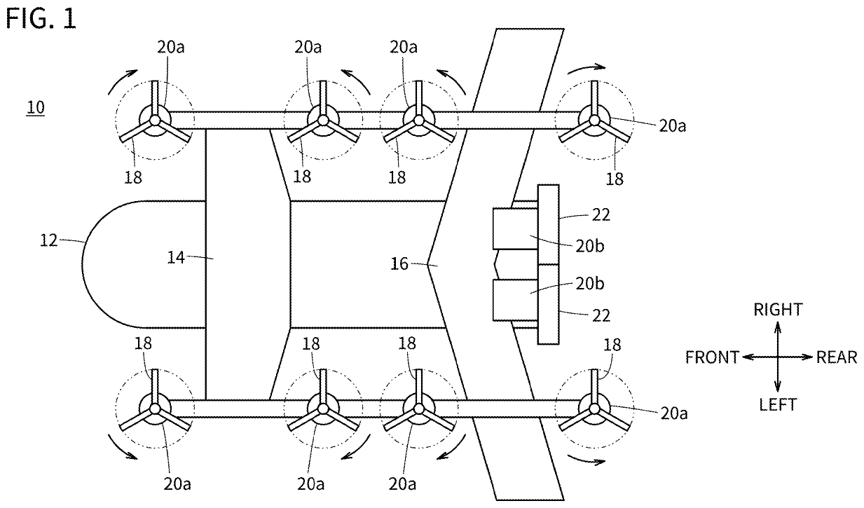

A description will be given with reference to the accompanying drawings concerning an electrical power supply system, a moving object, a control method, a program, and a storage medium according to the one embodiment. FIG. 1 is a schematic diagram of the moving object according to the present embodiment. A moving object 10 according to the present embodiment, for example, is an electric vertical takeoff and landing aircraft (eVTOL aircraft), although the moving object is not necessarily limited to this feature. The moving object 10 may be a vehicle, a ship, or the like. The moving object 10 includes a fuselage 12. A cockpit, a cabin, and the like are provided in the fuselage 12. A pilot sits in the cockpit, and controls the moving object 10. Passengers and others board and ride in the cabin. The moving object 10 may be automatically controlled.

The moving object 10 has a front wing 14 and a rear wing 16. In the case that the moving object 10 moves frontward, a lift is generated respectively on each of the front wing 14 and the rear wing 16.

The moving object 10 is equipped with eight VTOL rotors 18, and two cruise rotors 22. One electric motor (VTOL electric motor) 20a is provided with respect to each of the VTOL rotors 18. The electric motor 20a, for example, is a single three phase motor. One electric motor (cruise electric motor) 20b can be provided with respect to one cruise rotor 22. The electric motor 20b, for example, is a dual three phase motor.

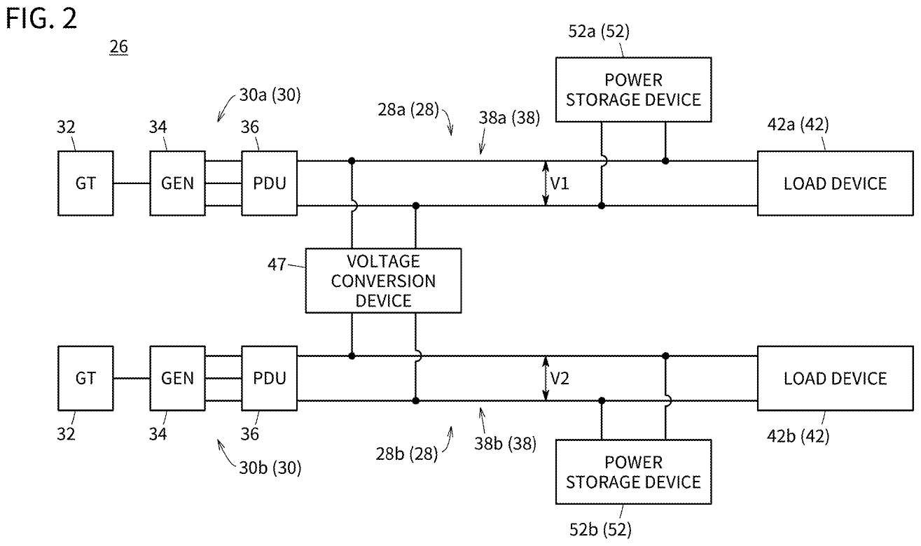

FIG. 2 is a schematic diagram showing a configuration of the electrical power supply system according to the present embodiment. The electrical power supply system 26 is equipped with a plurality of electrical power supply subsystems 28. The plurality of electrical power supply subsystems 28 include an electrical power supply subsystem (first electrical power supply subsystem) 28a and an electrical power supply subsystem (second electrical power supply subsystem) 28b. The electrical power supply system 26 is equipped with an electrical power generating device (first electrical power generating device) 30a and an electrical power generating device (second electrical power generating device) 30b that serve main electrical power sources. The DC power output from the electrical power generating device 30a is supplied to the electrical power supply subsystem 28a. The DC power output from the electrical power generating device 30b is supplied to the electrical power supply subsystem 28b. When the individual electrical power supply systems are described while distinguishing therebetween, the reference numerals 28a and 28b will be used, and when the individual electrical power supply systems are described without distinguishing therebetween, the reference numeral 28 will be used. When the individual electrical power generating devices are described while distinguishing therebetween, the reference numerals 30a and 30b will be used, and when the individual electrical power generating devices are described without distinguishing therebetween, the reference numeral 30 will be used.

The electrical power generating device 30 is equipped with a gas turbine engine 32 as a driving source, but is not limited thereto. The electrical power generating device 30 is further equipped with a generator (starter generator) 34. The electrical power generating device 30 is still further equipped with a power drive unit (hereinafter, referred to as PDU) 36. An output shaft of the gas turbine engine 32 is connected to a rotating shaft of the generator 34. The gas turbine engine 32 drives the generator 34. In accordance with this feature, generation of electrical power is carried out by the generator 34. The PDU 36 converts and outputs an AC electrical power generated by the generator 34 into a DC electrical power. In the case that the gas turbine engine 32 is started, the PDU 36 converts the DC electrical power that was input to the PDU 36 into a three phase AC electrical power, and outputs the AC electrical power to the generator 34. The generator 34 receives the AC electrical power to operate as a starter motor, and can cause the gas turbine engine 32 to start. The generator 34 is not limited to the starter generator, and may be a generator that generates only electrical power, and in this case, a starter motor that causes the gas turbine engine to start is provided in addition to the generator.

The electrical power generating device 30 may include various elements, such as various sensors such as voltage sensors, electrical current sensors or the like, fuses, relays, breakers, diodes, transistors, resistors, coils, capacitors, and the like.

The electrical power supply subsystem 28a includes an electrical power supply circuit (first electrical power supply circuit) 38a. The electrical power supply subsystem 28a may include a plurality of electrical power supply circuits 38a, but one electrical power supply circuit 38a among the plurality of electrical power supply circuits 38a is illustrated. The electrical power supply subsystem 28b includes an electrical power supply circuit (second electrical power supply circuit) 38b. The electrical power supply subsystem 28b may include a plurality of electrical power supply circuits 38b, and one electrical power supply circuit 38b of the plurality of electrical power supply circuits 38b is illustrated. When the individual electrical power supply circuits are described while distinguishing therebetween, the reference numerals 38a and 38b will be used, and when the individual electrical power supply circuits are described without distinguishing therebetween, the reference numeral 38 will be used.

The electrical power supply system 26 may be equipped with a plurality of load devices 42. In the plurality of load devices 42, there may be included a load device (first load device) 42a and a load device (second load device) 42b. The electrical power supply circuit 38a supplies a DC electrical power that is supplied from the electrical power generating device 30a to the load device 42a. The electrical power supply circuit 38b supplies a DC electrical power that is supplied from the electrical power generating device 30b to the load device 42b. When the individual load devices are described while distinguishing therebetween, the reference numerals 42a and 42b will be used, and when the individual load devices are described without distinguishing therebetween, the reference numeral 42 will be used.

The load device 42 includes, for example, a drive device (not shown) and an electric motor (not shown), but is not limited thereto. The drive device is an inverter having a non-illustrated switching element. By the switching element being controlled, the drive device converts direct current power input to the drive device into three-phase alternating current power and outputs the three-phase alternating current power to the electric motor.

Each of the respective load devices 42 may include various elements, such as various sensors such as voltage sensors, electrical current sensors or the like, fuses, relays, breakers, diodes, transistors, resistors, coils, capacitors, and the like.

The electrical power supply system 26 includes a plurality of power storage devices 52. In the plurality of power storage devices 52, there may be included a power storage device (first power storage device) 52a and a power storage device (second power storage device) 52b. When the individual power storage devices are described while distinguishing therebetween, the reference numerals 52a and 52b will be used, and when the individual power storage devices are described without distinguishing therebetween, the reference numeral 52 will be used. The power storage devices 52 can be connected to each of the electrical power supply circuits 38. The power storage devices 52 can be connected in parallel with the electrical power generating device 30. Each of the power storage devices 52 includes a non-illustrated battery. The battery, for example, is a lithium ion battery. The rated output voltage of the power storage devices 52, for example, is several hundred volts, although the power storage devices are not necessarily limited to this feature.

Each of the respective power storage devices 52 may include various elements, such as various sensors such as voltage sensors, electrical current sensors or the like, fuses, relays, breakers, diodes, transistors, resistors, coils, capacitors, and the like.

The electrical power supply system 26 includes a voltage conversion device 47. The voltage conversion device 47 is capable of converting the DC electrical power that is supplied from the electrical power supply subsystem 28a and supplying the converted DC electrical power to the electrical power supply subsystem 28b. The voltage conversion device 47 is capable of converting the DC electrical power that is supplied from the electrical power supply subsystem 28b and supplying the converted DC electrical power to the electrical power supply subsystem 28a.

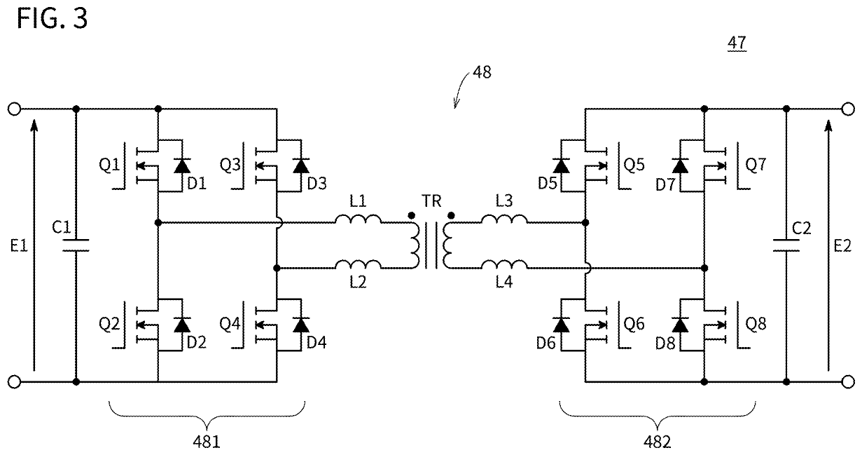

The voltage conversion devices 47 comprise, for example, a bidirectional DC/DC converter 48 with a variable transformation ratio. FIG. 3 is a circuit diagram showing an example of the DC/DC converter. The DC/DC converter 48, for example, is a DAB (Dual Active Bridge) converter, although the DC/DC converter is not necessarily limited to this feature. The DC/DC converter 48 is equipped with a non-illustrated electrical current limiting function that limits the output electrical current to less than or equal to a predetermined electrical current limit value. Further, the DC/DC converter 48 is capable of carrying out a constant voltage (Constant Voltage: CV) control in order to maintain a stable output voltage. The DC/DC converter 48 may be equipped with switching elements Q1 to Q8, an inductor L1 to L4, rectifying diodes D1 to D8, smoothing capacitors C1 and C2, and an insulating transformer TR, but is not limited thereto. A full-bridge circuit 481 including switching elements Q1, Q2, Q3, and Q4 is provided on the primary side of the DC/DC converter 48. A full-bridge circuit 482 including switching elements Q5, Q6, Q7, and Q8 is provided on the secondary side of the DC/DC converter 48. An isolation transformer TR and inductors L1 to L4 are provided between the full-bridge circuit 481 and the full-bridge circuit 482. In a state in which the switching element Q5 to Q8 are set to OFF, when the pair of the switching element Q1 and the switching element Q4 and the pair of the switching element Q2 and the switching element Q3 are alternately switched at a high frequency, the DC voltage E1 on the primary side is converted into an AC voltage, and the AC voltage is supplied to the secondary side via the insulating transformer TR. The AC voltage that is supplied to the secondary side is smoothed by the smoothing capacitor C2, and a DC voltage E2 is obtained. On the other hand, in a state in which the switching element Q1 to Q4 are set to OFF, when the pair of the switching element Q5 and the switching element Q8 and the pair of the switching element Q6 and the switching element Q7 are alternately switched at a high frequency, the DC voltage E2 on the secondary side is converted into an AC voltage, and the AC voltage is supplied to the primary side via the insulating transformer TR. The AC voltage that is supplied to the primary side is smoothed by the smoothing capacitor C1, and a DC voltage E1 is obtained. In the above description, although an example has been described in which the primary side and the secondary side are insulated by the DC/DC converter 48, the present invention is not necessarily limited to this feature. A non-insulated DC/DC converter in which the primary side and the secondary side are not insulated may also be provided in the voltage conversion devices 47. The transformation ratio of the voltage conversion devices 47 can be controlled by a control unit 92.

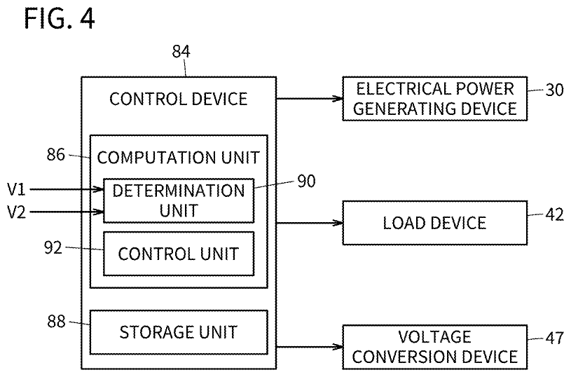

The electrical power supply system 26 is equipped with a control device 84. FIG. 4 is a block diagram showing a configuration of the control device according to the present embodiment.

As shown in FIG. 4, the control device 84 includes a computation unit 86 and a storage unit 88. The computation unit 86 includes a processor such as a CPU (Central Processing Unit) or a GPU (Graphics Processing Unit) or the like. The computation unit 86 includes a determination unit 90 and the control unit 92. The determination unit 90 and the control unit 92 are realized by the computation unit 86 executing a program that is stored in the storage unit 88. At least a portion of the determination unit 90 and the control unit 92 may be realized by an integrated circuit such as an ASIC (Application Specific Integrated Circuit) or an FPGA (Field Programmable Gate Array) or the like. At least one of the determination unit 90 and the control unit 92 may be realized by an electronic circuit including a discrete device.

The storage unit 88 is a computer readable non-transitory tangible storage medium. The storage unit 88 is constituted by a non-illustrated volatile memory, and a non-illustrated non-volatile memory. The volatile memory, for example, is a RAM (Random Access Memory) or the like. The non-volatile memory, for example, is a ROM (Read Only Memory), a flash memory, or the like. Data and the like are stored, for example, in the volatile memory. A program, a table, a map, and the like are stored, for example, in the nonvolatile memory. At least a portion of the storage unit 88 may be provided in the aforementioned processor, the integrated circuit, or the like. At least a portion of the storage unit 88 may be installed in a device that is connected by a network to the moving object 10.

As noted previously, the control unit 92 may be provided in the control device 84. The control unit 92 is responsible for the overall control of the control device 84. The control unit 92 is capable of controlling each of the electrical power generating devices 30, the load devices 42, and the voltage conversion device 47. Moreover, a distributed control may be carried out by the control unit 92 that is provided in each of the plurality of control devices 84.

In the case where electrical power that needs to be supplied from the electrical power generating device 30 to the load device 42 via the electrical power supply circuit 38 is rapidly increased, it is necessary to increase the electrical power generated by the electrical power generating device 30 that supplies electrical power to the load device 42, but the gas turbine engine 32 provided as a driving source in the electrical power generating device 30 has a relatively low responsiveness. Therefore, the shortage of the electrical power is compensated for by increasing the supply of the electrical power from the power storage device 52 to the electrical power supply circuit 38. However, since the power storage device 52 has a certain degree of internal resistance, as the current supplied from the power storage device 52 to the electrical power supply circuit 38 increases, the voltage drop in the power storage device 52 increases. As the voltage drop in the power storage device 52 increases, the voltage of the electrical power supply circuit 38 connected to the power storage device 52 decreases. As the voltage of the electrical power supply circuit 38 is extremely decreased, it becomes difficult to increase the electrical power generated by the electrical power generating device 30. In order to avoid the occurrence of such an event, the control unit 92 can execute the following power interchange control for transferring electrical power between the electrical power supply subsystem 28a and the electrical power supply subsystem 28b via the voltage conversion device 47.

As noted previously, the determination unit 90 may be provided in the control device 84. The determination unit 90 acquires a voltage V1 supplied from the electrical power supply subsystem 28a and a voltage V2 supplied from the electrical power supply subsystem 28b. The determination unit 90 determines whether the voltage difference ΔV that is the difference between the voltage V1 and the voltage V2 is equal to or greater than a predetermined first difference threshold Vth1. The first difference threshold Vth1 is a threshold value for determining whether or not the electrical power interchange between the electrical power supply subsystems 28 is required. The voltage V1 can be acquired using a voltage sensor (not shown) that measures a voltage between the positive electrode and the negative electrode of the electrical power supply subsystem 28a. The voltage V2 can be acquired using a voltage sensor (not shown) that measures a voltage between the positive electrode and the negative electrode of the electrical power supply subsystem 28b. The determination unit 90 can acquire the current flowing through each of the electrical power supply subsystems 28a and 28b. The current flowing through the electrical power supply subsystem 28a can be acquired using a current sensor (not shown) provided in the electrical power supply subsystem 28a. The current flowing through the electrical power supply subsystem 28b can be acquired using a current sensor (not shown) provided in the electrical power supply subsystem 28b. The determination unit 90 can calculate the generated power in each of the electrical power generating devices 30a and 30b based on the voltage and the current described above.

When the determination unit 90 determines that the voltage difference ΔV is equal to or greater than the first difference threshold Vth1, the control unit 92 executes the power interchange control. When the determination unit 90 determines that the voltage difference ΔV obtained by subtracting the voltage V2 from the voltage V1 is positive, the control unit 92 executes power interchange control to transfer electrical power from the electrical power supply subsystem 28a to the electrical power supply subsystem 28b. When electrical power is transferred from the electrical power supply subsystem 28a to the electrical power supply subsystem 28b, an increase in the current supplied from the power storage device 52b to the electrical power supply circuit 38b is suppressed, thereby suppressing a voltage drop in the power storage device 52b. When the voltage drop in the power storage device 52b is suppressed, the voltage drop in the electrical power supply circuit 38b is suppressed.

The magnitude of the interchange power, which is electrical power transferred from one electrical power supply subsystem 28 to the other electrical power supply subsystem 28, may be determined, for example, based on the generated power of each electrical power generating device 30 and the voltage difference ΔV. An unillustrated map indicating a relationship between the magnitude of the interchange power, the generated power of each electrical power generating device 30, and the voltage difference ΔV is stored in advance in the storage unit 88, and the control unit 92 can determine the magnitude of the interchange power using the map.

When the determination unit 90 determines that the voltage difference ΔV obtained by subtracting the voltage V2 from the voltage V1 is negative, the control unit 92 executes power interchange control to transfer electrical power from the electrical power supply subsystem 28b to the electrical power supply subsystem 28a. When electrical power is transferred from the electrical power supply subsystem 28b to the electrical power supply subsystem 28a, an increase in the current supplied from the power storage device 52a to the electrical power supply circuit 38a is suppressed, thereby suppressing a voltage drop in the power storage device 52a. When the voltage drop in the power storage device 52a is suppressed, the voltage drop in the electrical power supply circuit 38a is suppressed.

The target voltage VT of the voltage conversion device 47 for performing the power interchange control may be set to an intermediate voltage between the voltage V1 and the voltage V2. The target output voltage VT may be determined based on the following equation (1), but is not limited thereto.

VT=(V1+V2)/2 (1)

When the determination unit 90 determines that the voltage difference ΔV obtained by subtracting the voltage V2 from the voltage V1 is positive and the magnitude of the voltage difference ΔV is equal to or larger than a second difference threshold Vth2 that is greater than the first difference threshold Vth1, the control unit 92 performs the following control. That is, in such a case, the control unit 92 increases the generated power of the electrical power generating device 30a, and executes the power interchange control for transferring electrical power from the electrical power supply subsystem 28a to the electrical power supply subsystem 28b. The second difference threshold Vth2 is a reference value for determining whether or not it is necessary to increase the electrical power generated by the electrical power generating device 30. Since the power generated by the electrical power generating device 30a increases, a decrease in the remaining amount of the power storage device 52a can be suppressed even though electrical power is transferred from the electrical power supply subsystem 28a to the electrical power supply subsystem 28b. The reason for increasing the power generated by the electrical power generating device 30a is that, while it is possible for the electrical power generating device 30a whose output voltage is relatively high to increase the generated power, it may not be possible for the electrical power generating device 30b whose output voltage is relatively low to increase the generated power.

When the determination unit 90 determines that the voltage difference ΔV obtained by subtracting the voltage V2 from the voltage V1 is negative and the magnitude of the voltage difference ΔV is equal to or larger than the second difference threshold Vth2, the control unit 92 performs the following control. That is, in such a case, the control unit 92 increases the generated power of the electrical power generating device 30b, and executes the power interchange control for transferring electrical power from the electrical power supply subsystem 28b to the electrical power supply subsystem 28a. Since the power generated by the electrical power generating device 30b increases, a decrease in the remaining amount of the power storage device 52b can be suppressed even though electrical power is transferred from the electrical power supply subsystem 28b to the electrical power supply subsystem 28a. The reason for increasing the power generated by the electrical power generating device 30b is that, while it is possible for the electrical power generating device 30b whose output voltage is relatively high to increase the generated power, it may not be possible for the electrical power generating device 30a whose output voltage is relatively low to increase the generated power.

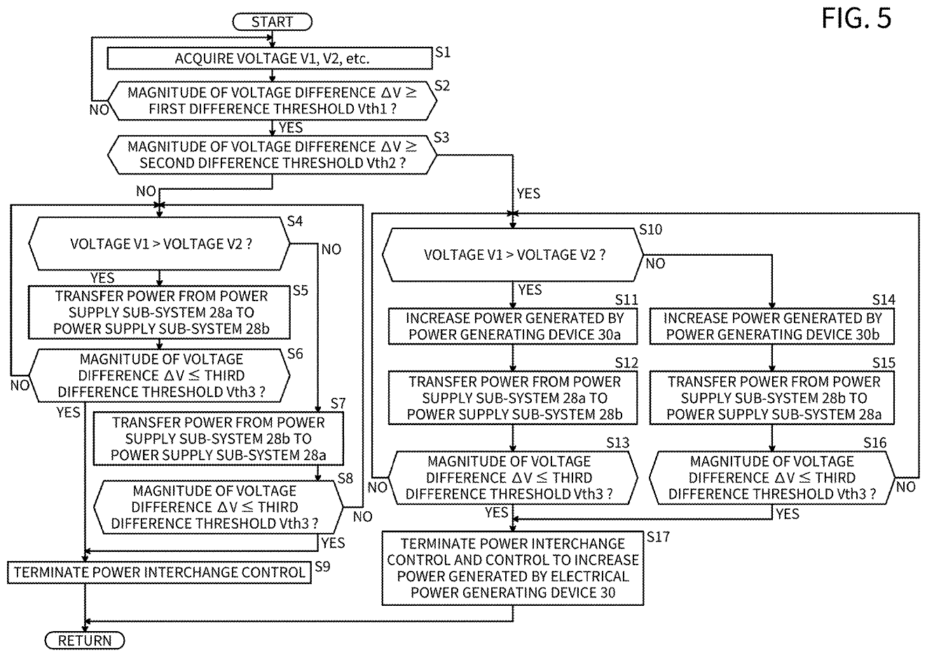

A description will be given with reference to FIG. 5 concerning an example of operations of the electrical power supply system according to the present embodiment. FIG. 5 is a flowchart showing an example of operations of the electrical power supply system according to the present embodiment.

In step S1, the determination unit 90 acquires the voltages V1, V2, and the like. As described above, the voltage V1 is the voltage supplied by the electrical power supply subsystem 28a. As described above, the voltage V2 is the voltage supplied by the electrical power supply subsystem 28b. In step S1, the values of the currents flowing through the electrical power supply subsystems 28a and 28b may be further acquired. In step S1, the electrical power generated in each of the electrical power generating devices 30a and 30b can be calculated based on the voltage and the current described above. Thereafter, the process transitions to step S2.

In step S2, the determination unit 90 determines whether the magnitude of the voltage difference ΔV between the voltage V1 and the voltage V2 is equal to or larger than the first difference threshold Vth1. When the magnitude of the voltage difference ΔV is less than the first difference threshold Vth1 (NO in step S2), the process is repeated from step S1. When the magnitude of the voltage difference ΔV is equal to or larger than the first difference threshold Vth1 (YES in step S2), the process transitions to step S3.

In step S3, the determination unit 90 determines whether the magnitude of the voltage difference ΔV is equal to or larger than the second difference threshold Vth2 that is greater than the first difference threshold Vth1. When the magnitude of the voltage difference ΔV is equal to or larger than the second difference threshold Vth2 (YES in step S3), the process transitions to step S10. When the magnitude of the voltage difference ΔV is less than the second difference threshold Vth2 (NO in step S3), the process transitions to step S4.

In step S4, the determination unit 90 determines whether or not the voltage V1 of the first electrical power supply subsystem 28a is higher than the voltage V2 of the second electrical power supply subsystem 28b. In the case where the determination unit 90 determines that the voltage V1 of the electrical power supply subsystem 28a is higher than the voltage V2 of the electrical power supply subsystem 28b (YES in step S4), the process transitions to step S5. In the case where the determination unit 90 determines that the voltage V1 of the electrical power supply subsystem 28a is lower than the voltage V2 of the electrical power supply subsystem 28b (NO in step S4), the process transitions to step S7.

In step S5, the control unit 92 controls the voltage conversion device 47 to execute the power interchange control for transferring electrical power from the electrical power supply subsystem 28a to the electrical power supply subsystem 28b. Thereafter, the process transitions to step S6.

In step S6, the determination unit 90 determines whether or not the voltage V1 of the electrical power supply subsystem 28a and the voltage V2 of the electrical power supply subsystem 28b are substantially equal to each other. Whether the voltage V1 of the electrical power supply subsystem 28a and the voltage V2 of the electrical power supply subsystem 28b are substantially equal to each other may be determined based on whether the voltage difference ΔV between the voltage V1 of the electrical power supply subsystem 28a and the voltage V2 of the electrical power supply subsystem 28b is equal to or less than a predetermined third difference threshold Vth3. The third difference threshold Vth3 is a reference value for determining whether or not the voltage V1 and the voltage V2 are equal to each other, and is set to be sufficiently small. The third difference threshold Vth3 may be zero. In the case where the determination unit 90 determines that the voltage V1 of the electrical power supply subsystem 28a and the voltage V2 of the electrical power supply subsystem 28b are not equal to each other (NO in step S6), the process is repeated from step S4. In the case where the determination unit 90 determines that the voltage V1 of the electrical power supply subsystem 28a and the voltage V2 of the electrical power supply subsystem 28b are equal to each other (YES in step S6), the process transitions to step S9.

As described above, in the case where the determination unit 90 determines that the voltage V1 of the electrical power supply subsystem 28a is lower than the voltage V2 of the electrical power supply subsystem 28b (NO in step S4), the process transitions to step S7. In step S7, the control unit 92 controls the voltage conversion device 47 to execute the power interchange control for transferring electrical power from the electrical power supply subsystem 28b to the electrical power supply subsystem 28a. Thereafter, the process transitions to step S8.

In step S8, the determination unit 90 determines whether or not the voltage V1 of the electrical power supply subsystem 28a and the voltage V2 of the electrical power supply subsystem 28b are substantially equal to each other. As in step S6, whether the voltage V1 of the electrical power supply subsystem 28a and the voltage V2 of the electrical power supply subsystem 28b are substantially equal to each other may be determined based on whether the voltage difference ΔV between the voltage V1 of the electrical power supply subsystem 28a and the voltage V2 of the electrical power supply subsystem 28b is equal to or less than the predetermined third difference threshold Vth3. As described above, the third difference threshold Vth3 is a reference value for determining whether or not the voltage V1 and the voltage V2 are equal to each other, and is set to be sufficiently small. As described above, the third difference threshold Vth3 may be zero. In the case where the determination unit 90 determines that the voltage V1 of the electrical power supply subsystem 28a and the voltage V2 of the electrical power supply subsystem 28b are not equal to each other (NO in step S8), the process is repeated from step S4. In the case where the determination unit 90 determines that the voltage V1 of the electrical power supply subsystem 28a and the voltage V2 of the electrical power supply subsystem 28b are equal to each other (YES in step S8), the process transitions to step S9.

In step S9, the control unit 92 brings the power interchange control to an end. Upon completion of step S9, the process shown in FIG. 5 comes to an end.

As described above, in the case where the magnitude of the voltage difference ΔV is equal to or larger than the second difference threshold Vth2 (YES in step S3), the process transitions to step S10. In step S10, the determination unit 90 determines whether or not the voltage V1 of the first electrical power supply subsystem 28a is higher than the voltage V2 of the second electrical power supply subsystem 28b. In the case where the determination unit 90 determines that the voltage V1 of the electrical power supply subsystem 28a is higher than the voltage V2 of the electrical power supply subsystem 28b (YES in step S10), the process transitions to step S11. In the case where the determination unit 90 determines that the voltage V1 of the electrical power supply subsystem 28a is lower than the voltage V2 of the electrical power supply subsystem 28b (NO in step S10), the process transitions to step S14.

In step S11, the control unit 92 performs control to increase the electrical power generated by the electrical power generating device 30a. Thereafter, the process transitions to step S12.

In step S12, the control unit 92 controls the voltage conversion device 47 to execute the power interchange control for transferring electrical power from the electrical power supply subsystem 28a to the electrical power supply subsystem 28b. Thereafter, the process transitions to step S13.

In step S13, the determination unit 90 determines whether or not the voltage V1 of the electrical power supply subsystem 28a and the voltage V2 of the electrical power supply subsystem 28b are substantially equal to each other. As in step S6, whether the voltage V1 of the electrical power supply subsystem 28a and the voltage V2 of the electrical power supply subsystem 28b are substantially equal to each other may be determined based on whether the voltage difference ΔV between the voltage V1 of the electrical power supply subsystem 28a and the voltage V2 of the electrical power supply subsystem 28b is equal to or less than the predetermined third difference threshold Vth3. As described above, the third difference threshold Vth3 is a reference value for determining whether or not the voltage V1 and the voltage V2 are equal to each other, and is set to be sufficiently small. As described above, the third difference threshold Vth3 may be zero. In the case where the determination unit 90 determines that the voltage V1 of the electrical power supply subsystem 28a and the voltage V2 of the electrical power supply subsystem 28b are not equal to each other (NO in step S13), the process is repeated from step S10. In the case where the determination unit 90 determines that the voltage V1 of the electrical power supply subsystem 28a and the voltage V2 of the electrical power supply subsystem 28b are equal to each other (YES in step S13), the process transitions to step S17.

As described above, in the case where the determination unit 90 determines that the voltage V1 of the electrical power supply subsystem 28a is lower than the voltage V2 of the electrical power supply subsystem 28b (NO in step S10), the process transitions to step S14.

In step S14, the control unit 92 performs control to increase the electrical power generated by the electrical power generating device 30b. Thereafter, the process transitions to step S15.

In step S15, the control unit 92 controls the voltage conversion device 47 to execute the power interchange control for transferring electrical power from the electrical power supply subsystem 28b to the electrical power supply subsystem 28a. Thereafter, the process transitions to step S16.

In step S16, the determination unit 90 determines whether or not the voltage V1 of the electrical power supply subsystem 28a and the voltage V2 of the electrical power supply subsystem 28b are substantially equal to each other. As in step S6, whether the voltage V1 of the electrical power supply subsystem 28a and the voltage V2 of the electrical power supply subsystem 28b are substantially equal to each other may be determined based on whether the voltage difference ΔV between the voltage V1 of the electrical power supply subsystem 28a and the voltage V2 of the electrical power supply subsystem 28b is equal to or less than the predetermined third difference threshold Vth3. As described above, the third difference threshold Vth3 is a reference value for determining whether or not the voltage V1 and the voltage V2 are equal to each other, and is set to be sufficiently small. As described above, the third difference threshold Vth3 may be zero. In the case where the determination unit 90 determines that the voltage V1 of the electrical power supply subsystem 28a and the voltage V2 of the electrical power supply subsystem 28b are not equal to each other (NO in step S16), the process is repeated from step S10. In the case where the determination unit 90 determines that the voltage V1 of the electrical power supply subsystem 28a and the voltage V2 of the electrical power supply subsystem 28b are equal to each other (YES in step S16), the process transitions to step S17.

In step S17, the control unit 92 brings the power interchange control to an end and also brings the control to increase the electrical power generated by the electrical power generating device 30 to an end. Upon completion of step S17, the process shown in FIG. 5 comes to an end.

As described above, according to the present embodiment, the voltage conversion device 47 is provided which can convert the DC voltage supplied from the electrical power supply subsystem 28a and supply the converted DC voltage to the electrical power supply subsystem 28b, and can convert the DC voltage supplied from the electrical power supply subsystem 28b and supply the converted DC voltage to the electrical power supply subsystem 28a. Therefore, according to the present embodiment, electrical power can be transferred between the electrical power supply subsystem 28a and the electrical power supply subsystem 28b in a state where there is a potential difference between the electrical power supply subsystem 28a and the electrical power supply subsystem 28b. Therefore, according to the present embodiment, electrical power can be rapidly transferred among the electrical power supply subsystems 28. Since the electrical power can be rapidly transferred among the electrical power supply subsystems 28, it is not necessary to improve the responsiveness of the gas turbine engine or the like provided as a driving source in the electrical power generating device 30. Further, because electrical power can be rapidly transferred among the electrical power supply subsystems 28, the storage capacity of the power storage device 52 can be reduced, thereby enabling the power storage device 52 to be made lighter. The reduction in weight of the power storage device 52 contributes to an increase in the cruising distance of the moving object 10. In this manner, according to the present embodiment, a satisfactory electrical power supply system 26 can be provided.

### Modifications

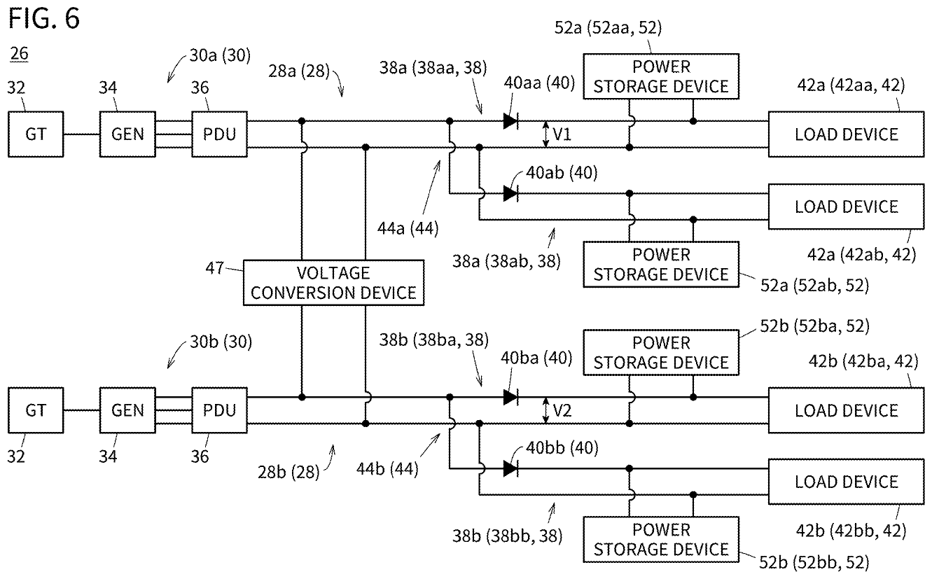

FIG. 6 is a schematic diagram showing a configuration of the electrical power supply system according to an exemplary modification. As shown in FIG. 6, the electrical power supply subsystem (first electrical power supply subsystem) 28a includes a plurality of electrical power supply circuits 38a. To be specific, the electrical power supply subsystem 28a includes an electrical power supply circuit (first electrical power supply circuit) 38aa and an electrical power supply circuit (third electrical power supply circuit) 38ab. The electrical power supply subsystem (second electrical power supply subsystem) 28b includes a plurality of electrical power supply circuits 38b. To be specific, the electrical power supply subsystem 28b includes an electrical power supply circuit (second electrical power supply circuit) 38ba and an electrical power supply circuit (fourth electrical power supply circuit) 38bb.

The electrical power supply circuit 38ab branches off from the electrical power supply circuit 38aa. To be specific, the electrical power supply circuit 38ab branches off from the electrical power supply circuit 38aa at the branch point 44a. The electrical power supply circuit 38bb branches off from the electrical power supply circuit 38ba. To be specific, the electrical power supply circuit 38bb branches off from the electrical power supply circuit 38ba at the branch point 44b.

The voltage conversion device 47 is connected to the electrical power supply subsystem 28a at a point between the branch point 44a and the electrical power generating device 30a. Further, the voltage conversion device 47 is connected to the electrical power supply subsystem 28b at a point between the branch point 44b and the electrical power generating device 30b. When the individual branch points are described while distinguishing therebetween, the reference numerals 44a and 44b will be used, and when the individual branch points are described without distinguishing therebetween, the reference numeral 44 will be used. In other words, the voltage conversion device 47 is connected to the electrical power supply subsystem 28a at a point between the electrical power generating device 30a and a point at which the electrical power supply circuit 38aa and the electrical power supply circuit 38ab are connected to each other, and is connected to the electrical power supply subsystem 28b at a portion between the electrical power generating device 30b and a point where the electrical power supply circuit 38ba and the electrical power supply circuit 38bb are connected to each other.

The electrical power supply subsystem 28a may be equipped with a plurality of load devices 42a. In the plurality of load devices 42a, there may be included a load device (first load device) 42aa and a load device (third load device) 42ab. The electrical power supply circuit 38aa supplies a DC electrical power that is supplied from the electrical power generating device 30a to the load device 42aa. The electrical power supply circuit 38ab supplies a DC electrical power that is supplied from the electrical power generating device 30a to the load device 42ab. The electrical power supply subsystem 28b may be equipped with a plurality of load devices 42b. In the plurality of load devices 42b, there may be included a load device (second load device) 42ba and a load device (fourth load device) 42bb. The electrical power supply circuit 38ba supplies a DC electrical power that is supplied from the electrical power generating device 30b to the load device 42ba. The electrical power supply circuit 38bb supplies a DC electrical power that is supplied from the electrical power generating device 30b to the load device 42bb.

The electrical power supply circuit 38aa is provided with a reverse flow prevention device (reverse flow prevention element) 40aa. The electrical power supply circuit 38ab is provided with a reverse flow prevention device 40ab. The electrical power supply circuit 38ba is provided with a reverse flow prevention device 40ba. The electrical power supply circuit 38bb is provided with a reverse flow prevention device 40bb. When the individual reverse flow prevention devices are described while distinguishing therebetween, the reference numerals 40aa, 40ab, 40ba and 40bb will be used, and when the individual reverse flow prevention devices are described without distinguishing therebetween, the reference numeral 40 will be used. The reverse flow prevention devices 40, for example, are diodes. The reverse flow prevention device 40 is disposed, for example, in a positive electrode of the electrical power supply circuit 38, but is not limited thereto. Each of the reverse flow prevention devices 40 may be disposed in a negative electrode of each of the electrical power supply circuits 38. The reverse flow prevention device 40aa is provided in the electrical power supply circuit 38aa at a point between the branch point 44a and the power storage device 52aa. The reverse flow prevention device 40ab is provided in the electrical power supply circuit 38ab at a point between the branch point 44a and the power storage device 52ab. The reverse flow prevention device 40ba is provided in the electrical power supply circuit 38ba at a point between the branch point 44b and the power storage device 52ba. The reverse flow prevention device 40bb is provided in the electrical power supply circuit 38bb at a point between the branch point 44b and the power storage device 52bb.

The anode of the diode that constitutes the reverse flow prevention device 40 is connected, for example, to the positive electrode of the electrical power generating device 30. The cathode of the diode that constitutes the reverse flow prevention device 40 is connected, for example, to the positive electrode of the load device 42 and the positive electrode of the power storage device 52. The reverse flow prevention device 40 prevents reverse flowing of the electrical current in the electrical power supply circuit 38. More specifically, the reverse flow prevention device 40 permits the electrical power to be supplied from the electrical power generating device 30 to the load devices 42, however, does not permit the electrical power to be supplied from the load devices 42 to the electrical power generating device 30.

According to the present modification, since the voltage conversion device 47 is connected to the electrical power supply circuits 38a and 38b at the points between the branch points 44 and the electrical power generating device 30, a single voltage conversion device 47 is sufficient regardless of the number of load devices 42. That is, according to the present modification, power interchange between the electrical power supply subsystems 28 can be performed without providing any additional voltage conversion device 47.

In relation to the above-described disclosure, the following supplementary notes are further disclosed.

### Supplementary Note 1

The electrical power supply system (26) of the present disclosure comprises the first electrical power supply subsystem (28a) including a first electrical power supply circuit (38a) that supplies, to a first load device (42a), a DC electrical power that is output from the first electrical power generating device (30a), the first power storage device (52a) that is capable of being connected in parallel with the first electrical power generating device to the first electrical power supply circuit, the second electrical power supply subsystem (28b) including the second electrical power supply circuit (38b) that supplies, to the second load device (42b), a DC electrical power that is output from the second electrical power generating device (30b), the second power storage device (52b) that is capable of being connected in parallel with the second electrical power generating device to the second electrical power supply circuit, the voltage conversion device (47) that is capable of converting the DC voltage (V1) that is supplied from the first electrical power supply subsystem and supplying the same to the second electrical power supply subsystem, and further capable of converting the DC voltage (V2) that is supplied from the second electrical power supply subsystem and supplying the same to the first electrical power supply subsystem, and the control unit (92) that is capable of executing power interchange control for transferring electrical power between the first electrical power supply subsystem and the second electrical power supply subsystem via the voltage conversion device.

In this manner, the voltage conversion device is provided which can convert the DC voltage supplied from the first electrical power supply subsystem and supply the converted DC voltage to the second electrical power supply subsystem, and can convert the DC voltage supplied from the second electrical power supply subsystem and supply the converted DC voltage to the first electrical power supply subsystem. Therefore, according to such a configuration, electrical power can be transferred between the first electrical power supply subsystem and the second electrical power supply subsystem in a state where there is a potential difference between the first electrical power supply subsystem and the second electrical power supply subsystem. Therefore, according to such a configuration, power can be quickly transferred between the electrical power supply systems. Since the electrical power can be rapidly transferred among the electrical power supply subsystems, it is not necessary to improve the responsiveness of the gas turbine engine or the like provided as a driving source in the electrical power generating device. Further, because electrical power can be rapidly transferred among the electrical power supply subsystems, the storage capacity of the power storage device can be reduced, thereby enabling the power storage device to be made lighter. The reduction in weight of the power storage device contributes to an increase in the cruising distance of the moving object. In this manner, in accordance with such a configuration, it is possible to provide a satisfactory electrical power supply system.

### Supplementary Note 2

The electrical power supply system according to Supplementary Note 1 may further include the determination unit (90) configured to determine whether or not a magnitude of the voltage difference (ΔV) between the first voltage (V1) supplied from the first electrical power supply subsystem and the second voltage (V2) supplied from the second electrical power supply subsystem is equal to or larger than the predetermined first difference threshold (Vth1), wherein the control unit may execute the power interchange control in a case where the determination unit determines that the magnitude of the voltage difference is equal to or larger than the first difference threshold.

### Supplementary Note 3

In the electrical power supply system according to Supplementary Note 2, in a case where the determination unit determines that the voltage difference obtained by subtracting the second voltage from the first voltage is positive, the control unit may execute the power interchange control for transferring electrical power from the first electrical power supply subsystem to the second electrical power supply subsystem, and in a case where the determination unit determines that the voltage difference obtained by subtracting the second voltage from the first voltage is negative, the control unit may execute the power interchange control for transferring electrical power from the second electrical power supply subsystem to the first electrical power supply subsystem.

### Supplementary Note 4

In the electrical power supply system according to Supplementary Note 3, in a case where the determination unit determines that the voltage difference obtained by subtracting the second voltage from the first voltage is positive and the magnitude of the voltage difference is equal to or larger than the second difference threshold (Vth2) that is greater than the first difference threshold, the control unit may execute control for increasing electrical power generated by the first power generating device and execute the power interchange control for transferring electrical power from the first electrical power supply subsystem to the second electrical power supply subsystem, and in a case where the determination unit determines that the voltage difference obtained by subtracting the second voltage from the first voltage is negative and the magnitude of the voltage difference is equal to or larger than the second difference threshold, the control unit may execute control for increasing electrical power generated by the second power generating device and execute the power interchange control for transferring electrical power from the second electrical power supply subsystem to the first electrical power supply subsystem. According to such a configuration, since the electrical power generated by the electrical power generating device in the source electrical power supply subsystem increases, a decrease in the remaining amount of the power storage device provided in the source electrical power supply subsystem can be suppressed.

### Supplementary Note 5

The electrical power supply system according to Supplementary Note 1, the first electrical power supply subsystem may further include a third electrical power supply circuit (38ab) configured to supply, to the third load device (42ab), DC electrical power output from the first electrical power generating device, the second electrical power supply subsystem may further include the fourth electrical power supply circuit (38bb) configured to supply, to the fourth load device (42bb), DC electrical power output from the second electrical power generating device, and the voltage conversion device may be connected to the first electrical power supply subsystem at a point between the first power generating device and a point at which the first electrical power supply circuit and the third electrical power supply circuit are connected to each other, and may be connected to the second electrical power supply subsystem at a point between the second electrical power generating device and a point at which the second electrical power supply circuit and the fourth electrical power supply circuit are connected to each other. According to such a configuration, even in a case where the electrical power supply circuit branches according to the number of load devices, power transfer between the electrical power supply subsystems can be performed without adding a voltage conversion device.

### Supplementary Note 6

In the electrical power supply system according to any one of Supplementary Notes 1 to 5, each of the first electrical power generating device and the second electrical power generating device may be equipped with a gas turbine engine (32) as a driving source.

### Supplementary Note 7

The moving object (10) according to the present disclosure is equipped with the electrical power supply system according to any one of Supplementary Notes 1 to 6.

### Supplementary Note 8

The control method of the present disclosure for controlling the electrical power supply system, wherein the electrical power supply system comprises the first electrical power supply subsystem including the first electrical power supply circuit that supplies, to the first load device, a DC electrical power that is output from the first electrical power generating device, the first power storage device that is capable of being connected in parallel with the first electrical power generating device to the first electrical power supply circuit, the second electrical power supply subsystem including the second electrical power supply circuit that supplies, to the second load device, a DC electrical power that is output from the second electrical power generating device, the second power storage device that is capable of being connected in parallel with the second electrical power generating device to the second electrical power supply circuit, the voltage conversion device that is capable of converting a DC voltage that is supplied from the first electrical power supply subsystem and supplying the same to the second electrical power supply subsystem, and further capable of converting a DC voltage that is supplied from the second electrical power supply subsystem and supplying the same to the first electrical power supply subsystem, the control method comprising: the determination step (S2) of determining whether or not a voltage difference between a first voltage supplied from the first electrical power supply subsystem and a second voltage supplied from the second electrical power supply subsystem is equal to or greater than the predetermined first difference threshold; and the power interchange control step (S5, S7, S12, S15) of executing power interchange control for transferring electrical power between the first electrical power supply subsystem and the second electrical power supply subsystem via the voltage conversion device in the case where it is determined in the determination step that the voltage difference is equal to or greater than the first difference threshold.

### Supplementary Note 9

In the control method according to Supplementary Note 8, in the case where it is determined in the determination step that the voltage difference obtained by subtracting the second voltage from the first voltage is positive, the power interchange control for transferring electrical power from the first electrical power supply subsystem to the second electrical power supply subsystem may be executed in the power interchange step, and in the case where it is determined in the determination step that the voltage difference obtained by subtracting the second voltage from the first voltage is negative, the power interchange control for transferring electrical power from the second electrical power supply subsystem to the first electrical power supply subsystem may be executed in the power interchange step.

### Supplementary Note 10

In the control method according to Supplementary Note 9, in the case where it is determined in the determination step (S3) that the voltage difference obtained by subtracting the second voltage from the first voltage is positive and the magnitude of the voltage difference is equal to or larger than the second difference threshold that is greater than the first difference threshold, in the power interchange step, control for increasing electrical power to be generated by the first power generating device may be executed, and the power interchange control for transferring the electrical power from the first electrical power supply subsystem to the second electrical power supply subsystem may be executed, and in the case where it is determined that the voltage difference obtained by subtracting the second voltage from the first voltage is negative and the magnitude of the voltage difference is equal to or larger than the second difference threshold, in the power interchange step, control for increasing electrical power to be generated by the second power generating device may be executed, and the power interchange control for transferring the electrical power from the second electrical power supply subsystem to the first electrical power supply subsystem may be executed.

### Supplementary Note 11

The program of the present disclosure is a program in order to execute the control method according to any one of Supplementary Notes 8 to 10.

### Supplementary Note 12

The storage medium of the present disclosure is a non-transitory storage medium in which the program according to Supplementary Note 11 is stored.

Although concerning the present disclosure, a detailed description thereof has been presented above, the present disclosure is not necessarily limited to the individual embodiments described above. These embodiments may be subjected to various additions, substitutions, modifications, partial deletions, and the like, within a range that does not deviate from the essence and gist of the present disclosure, or the spirit of the present disclosure as derived from the contents described in the claims and equivalents thereof. Further, the embodiments can also be implemented together in combination. For example, in the above-described embodiments, the order of each of the operations and the order of each of the processes are illustrated as examples, and the present invention is not necessarily limited to these features. The same also applies to cases in which numerical values or mathematical expressions are used in the description of the aforementioned embodiments.

1. An electrical power supply system comprising:
a first electrical power supply subsystem including a first electrical power supply circuit configured to supply, to a first load device, a direct current electrical power that is output from a first electrical power generating device;
a first power storage device that is connectable in parallel with the first electrical power generating device to the first electrical power supply circuit;
a second electrical power supply subsystem including a second electrical power supply circuit configured to supply, to a second load device, a direct current electrical power that is output from a second electrical power generating device;
a second power storage device that is connectable in parallel with the second electrical power generating device to the second electrical power supply circuit;
a voltage conversion device configured to be able to convert a direct current voltage that is supplied from the first electrical power supply subsystem and supply a converted direct current voltage to the second electrical power supply subsystem, and further convert a direct current voltage that is supplied from the second electrical power supply subsystem and supply a converted direct current voltage to the first electrical power supply subsystem; and
one or more processors that execute computer-executable instructions stored in a memory,
wherein the one or more processors execute the computer-executable instructions to cause the electrical power supply system to:
execute power interchange control for transferring electrical power between the first electrical power supply subsystem and the second electrical power supply subsystem via the voltage conversion device.

2. The electrical power supply system according to claim 1, wherein the one or more processors execute the computer-executable instructions to cause the electrical power supply system to:
determine whether or not a magnitude of a voltage difference between a first voltage supplied from the first electrical power supply subsystem and a second voltage supplied from the second electrical power supply subsystem is equal to or larger than a first difference threshold determined in advance; and
execute the power interchange control in a case where the magnitude of the voltage difference is determined to be equal to or larger than the first difference threshold.

3. The electrical power supply system according to claim 2, wherein the one or more processors execute the computer-executable instructions to cause the electrical power supply system to:
execute the power interchange control for transferring electrical power from the first electrical power supply subsystem to the second electrical power supply subsystem in a case where the voltage difference obtained by subtracting the second voltage from the first voltage is determined to be positive; and
execute the power interchange control for transferring electrical power from the second electrical power supply subsystem to the first electrical power supply subsystem in a case where the voltage difference obtained by subtracting the second voltage from the first voltage is determined to be negative.

4. The electrical power supply system according to claim 3, wherein the one or more processors execute the computer-executable instructions to cause the electrical power supply system to:
in a case where the voltage difference obtained by subtracting the second voltage from the first voltage is determined to be positive and the magnitude of the voltage difference is determined to be equal to or larger than a second difference threshold that is greater than the first difference threshold, execute control for increasing electrical power generated by the first power generating device and execute the power interchange control for transferring electrical power from the first electrical power supply subsystem to the second electrical power supply subsystem; and
in a case where the voltage difference obtained by subtracting the second voltage from the first voltage is determined to be negative and the magnitude of the voltage difference is determined to be equal to or larger than the second difference threshold, execute control for increasing electrical power generated by the second power generating device and execute the power interchange control for transferring electrical power from the second electrical power supply subsystem to the first electrical power supply subsystem.

5. The electrical power supply system according to claim 1, wherein
the first electrical power supply subsystem further includes a third electrical power supply circuit configured to supply, to a third load device, direct current electrical power output from the first electrical power generating device,
the second electrical power supply subsystem further includes a fourth electrical power supply circuit configured to supply, to a fourth load device, direct current electrical power output from the second electrical power generating device, and
the voltage conversion device is connected to the first electrical power supply subsystem at a point between the first power generating device and a point at which the first electrical power supply circuit and the third electrical power supply circuit are connected to each other, and is connected to the second electrical power supply subsystem at a point between the second electrical power generating device and a point at which the second electrical power supply circuit and the fourth electrical power supply circuit are connected to each other.

6. The electrical power supply system according to claim 1, wherein each of the first electrical power generating device and the second electrical power generating device is equipped with a gas turbine engine as a driving source.

7. A moving object comprising the electrical power supply system according to claim 1.

8. A control method for controlling an electrical power supply system, wherein the electrical power supply system comprises:
a first electrical power supply subsystem including a first electrical power supply circuit configured to supply, to a first load device, a direct current electrical power that is output from a first electrical power generating device,
a first power storage device that is connectable in parallel with the first electrical power generating device to the first electrical power supply circuit,
a second electrical power supply subsystem including a second electrical power supply circuit configured to supply, to a second load device, a direct current electrical power that is output from a second electrical power generating device,
a second power storage device that is connectable in parallel with the second electrical power generating device to the second electrical power supply circuit, and
a voltage conversion device configured to be able to convert a direct current voltage that is supplied from the first electrical power supply subsystem and supply a converted direct current voltage to the second electrical power supply subsystem, and further convert a direct current voltage that is supplied from the second electrical power supply subsystem and supply a converted direct current voltage to the first electrical power supply subsystem,
the control method comprising:
determining whether or not a magnitude of a voltage difference between a first voltage supplied from the first electrical power supply subsystem and a second voltage supplied from the second electrical power supply subsystem is equal to or larger than a first difference threshold determined in advance; and
executing power interchange control for transferring electrical power between the first electrical power supply subsystem and the second electrical power supply subsystem via the voltage conversion device in a case where it is determined that the voltage difference is equal to or greater than the first difference threshold in the determining of the voltage difference.

9. The control method according to claim 8, wherein
in the executing of the power interchange control, the power interchange control for transferring electrical power from the first electrical power supply subsystem to the second electrical power supply subsystem is executed in a case where the voltage difference obtained by subtracting the second voltage from the first voltage is determined to be positive, in the determining of the voltage difference, and
in the executing of the power interchange control, the power interchange control for transferring electrical power from the second electrical power supply subsystem to the first electrical power supply subsystem is executed in a case where the voltage difference obtained by subtracting the second voltage from the first voltage is determined to be negative, in the determining of the voltage difference.

10. The control method according to claim 9, wherein
in a case where, in the determining of the voltage difference, the voltage difference obtained by subtracting the second voltage from the first voltage is determined to be positive and the magnitude of the voltage difference is determined to be equal to or larger than a second difference threshold that is greater than the first difference threshold, control for increasing electrical power generated by the first power generating device and the power interchange control for transferring electrical power from the first electrical power supply subsystem to the second electrical power supply subsystem are executed in the executing of the power interchange control, and
in a case where, in the determining of the voltage difference, the voltage difference obtained by subtracting the second voltage from the first voltage is determined to be negative and the magnitude of the voltage difference is determined to be equal to or larger than the second difference threshold, control for increasing electrical power generated by the second power generating device and the power interchange control for transferring electrical power from the second electrical power supply subsystem to the first electrical power supply subsystem are executed in the executing of the power interchange control.

11. A non-transitory storage medium in which there is stored a program in order to cause a computer to execute the control method according to claim 8.
